(19) United States
(12) Patent Application Publication
(10) Pub. No.: US 2006/0156514 A1
(43) Pub. Date: Jul. 20, 2006

(54) Auxiliary grip

(75) Inventor: Wayne Lewis, Santa Barbara, CA (US)

Correspondence Address: ROBERT W. BECKER & ASSOCIATES, Suite B, 707 State Hwy 333, Tijeras, NM, 87059-7507, US

(73) Assignee: New Mexico Technical Research Foundation, Socorro, NM (US)

(21) Appl. No.: 11/385,069

(22) Filed: Mar. 21, 2006

Related U.S. Application Data
(63) Continuation-in-part of application No. 10/737,001, filed on Dec. 16, 2003.

(51) Int. Cl. B25G 1/00

(52) U.S. Cl. 16/426

(57) ABSTRACT

An auxiliary grip comprising an oversized member that fits over the shaft of or for an object to form a handle or grip for the object. The oversized member has an elliptical cross-sectional shape over its entire length.

### CROSS-REFERENCE TO RELATED APPLICATIONS

This application is a continuation-in-part of pending application Ser. No. 10/737,001 filed Dec. 16, 2003.

### BACKGROUND OF THE INVENTION

The present invention relates to an auxiliary grip for an object, especially for the shaft of an object.

U.S. Pat. No. 6,148,482, Maraman, discloses a grip having a circular cross-section for a tool handle. The grip is made of elastomeric material so that it can conform to differently shaped handles.

There is a real need to provide a handle or grip for an object that makes it easier to hold and/or use the object.

It is therefore an object of the present invention to provide an improved, oversized grip for objects that provides a firmer grip, and facilitates a consistent hand position and better control of the object.

### BRIEF DESCRIPTION OF THE DRAWINGS

This object, and other objects and advantages of the present invention, will appear more clearly from the following specification in conjunction with the accompanying schematic drawing, in which:

FIG. 1 is an isometric view showing one exemplary embodiment of an auxiliary grip on a shaft;

FIGS. 2a and 2b are cross-sectional views showing the elliptical shape of the grip of FIG. 1;

FIG. 3 shows grip-enhancing material wrapped around the oversized member; and

FIG. 4 shows one half of a second exemplary embodiment of an auxiliary grip.

### SUMMARY OF THE INVENTION

The auxiliary grip of the present application comprises an oversized member that can be placed over the shaft of, or a shaft provided for, an object to form a handle or grip for the object; the oversized member has an elliptical cross-sectional shape over its entire length.

The oversized member can be a monolithic part, or can comprise at least two parts that are each provided with a recess and that fit together such that the recesses accommodate the shaft of or for an object, such as a ⅝ inch shaft.

The auxiliary grip of the present application has a multitude of uses. By way of example only, the auxiliary grip can be used for sports equipment, for example for racquet sports, golf, baseball or softball bats, ski poles, and fishing rods.

The use of cork as the material of the oversized member provides thermal, structural and shock absorption attributes. Furthermore, the density of the cork composite and the side wall depth are designed specifically for the torque and impact forces encountered in racket, baseball and golf sports.

Further specific features of the present application will be described in detail subsequently.

### DESCRIPTION OF SPECIFIC EMBODIMENTS

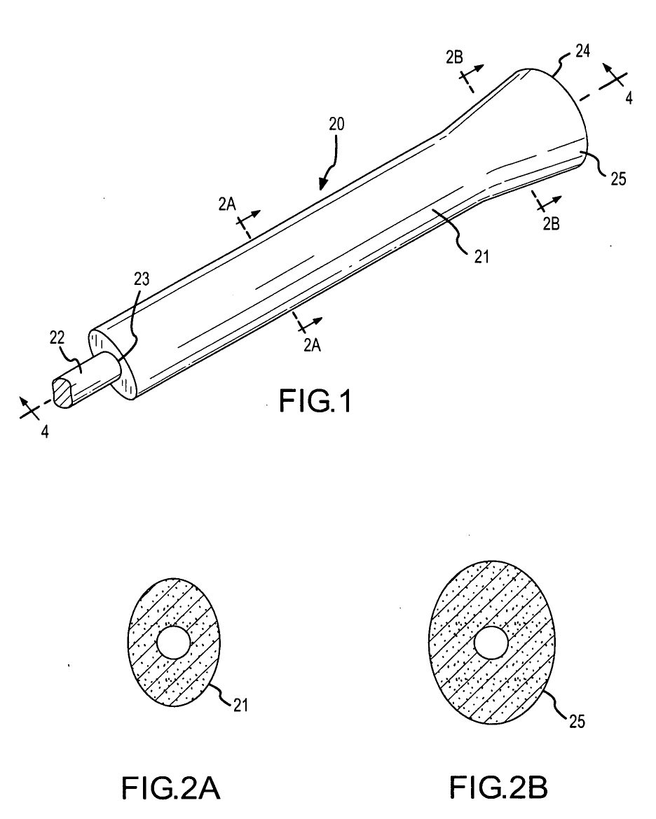

Referring now to the drawing in detail, FIG. 1 shows one embodiment of applicant's auxiliary grip, which is indicated generally by the reference numeral 20.

The auxiliary grip 20 comprises an oversized member 21, whereby the term oversized means that the member 21 is of a size that is larger than the size of a standard grip, especially in the aforementioned sports. In particular, the oversized member 21 is adapted to be placed over a shaft of, or a shaft that is to be attached to, an object, such as the illustrated shaft 22, to thereby form a new, oversized grip for the object. The oversized member 21 is provided with an appropriately sized bore 23, and furthermore can be glued or otherwise attached to the shaft, for example using standard adhesives or commercial grip tape and solvent, to prevent the member 21 from sliding or shifting on the shaft.

As can be seen in FIGS. 2a and 2b, the longer portion of the oversized member 21 has a specific elliptical cross-sectional shape, in particular having a width to length ratio of approximately 0.70. That end 24 of the member 21 that is remote from the object on which the auxiliary grip 20 is to be provided has a greater cross-sectional area than does the remainder of the member 21, with this enlarged portion being designated with the reference numeral 25. The enlarged portion 25 is much shorter than the remainder of the oversized member 21 and expediently tapers from the end 24 toward the remainder of the member 21. This enlarged portion 25 also has a specific elliptical cross-sectional shape, in particular having a width to length ratio of approximately 0.75 at the end 24, and represents the highest torque strength of the oversized member. Pursuant to one exemplary embodiment of the auxiliary grip of the present application, the uniform cross-section of the longer portion of the oversized member 21 can have a width of 1.125 inches and a length of 1.625 inches, while the shorter enlarged portion 25, at the end 24 of the member 21, can have a cross-section with a width of 1.5 inches and a length of 2.0 inches. The bore 23 of the oversized member 21 can have a diameter of 0.625 inches. In addition, the enlarged portion 25 of the member 21 can have an axial length of 1.5 inches, with an axial length of the remainder of the member 21 being 8.125 inches.

The auxiliary grip 20, i.e. the oversized member 21, is expediently made of cork. The use of cork allows the auxiliary grip 20 to maintain its shape after compression, provides water and mildew resistance, and provides the necessary strength to weight requirements for resisting strong energy moments.

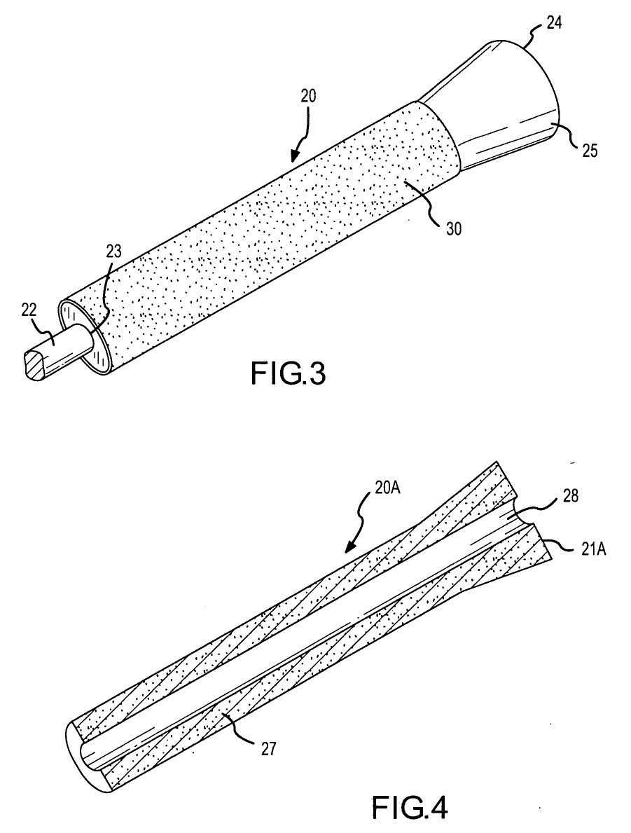

The oversized member 21 can additionally be at least partially wrapped or otherwise covered with a grip-enhancing material, which is indicated by the reference numeral 30 in FIG. 3.

Although in the embodiment illustrated in FIG. 1 the oversized member 21 is shown as a monolithic component, it would also be conceivable to make the member 21 in two or more parts. Therefore, a further embodiment of applicant's auxiliary grip is shown in FIG. 4, and is indicated generally by the reference numeral 20A.

In the illustrated embodiment of FIG. 4, the oversized member 21A is comprised of two essentially identical halves, only one of which is shown. In particular, the half member 27 is provided with a recess 28 that is adapted to fit over a portion of a shaft of an object. The same is true of the complementary, non-illustrated member of the oversized member 21A. The two half members 27 can again be glued or taped to one another and/or to the shaft of the object. The size of the recess 28 will, of course, vary, as was the case with the bore 23 of the member 21 of the embodiment of FIG. 1, depending upon the size of the shaft of the object. The oversized member could also comprise more than two parts.

The surface of the oversized members 21 and 21A can be a non uniform surface; for example, the surface can be provided with projections and/or grooves to enhance the gripping capability of the auxiliary grip 20, 20A.

The present invention is, of course, in no way restricted to the specific disclosure of the specification and drawing, but also encompasses any modifications within the scope of the appended claims.

I claim:

1. An auxiliary grip for an object, comprising:
an oversized member that is adapted to be placed over a shaft of, or a shaft provided for, an object to form a handle or grip for the object, wherein said oversized member has an elliptical cross-sectional shape over the entire length thereof.

2. A grip according to claim 1, wherein said oversized member is a monolithic part.

3. A grip according to claim 2, wherein said oversized member has a bore for accommodating the shaft.

4. A grip according to claim 3, wherein said oversized member is glued or attached with grip tape to the shaft.

5. A grip according to claim 1, wherein said oversized member comprises at least two parts that are each provided with a recess and that fit together such that said recesses accommodate the shaft.

6. A grip according to claim 5, wherein said two parts are glued together and/or to the shaft.

7. A grip according to claim 1, wherein said oversized member is made of cork or rubberized composite having the specific properties of cork.

8. A grip according to claim 1, wherein said oversized member is at least partially wrapped or covered with material.

9. A grip according to claim 8, wherein said material is a grip-enhancing material.

10. A grip according to claim 1, wherein said oversized member has two ends, one of which has a greater cross-sectional area than does the remainder of said oversized member, which remainder has a constant cross-sectional area.

11. A grip according to claim 11, wherein said end of greater cross-sectional area tapers down toward the remainder of said oversized member.

12. A grip according to claim 11, wherein the remainder of said oversized member has a length that is several times a length of said end of greater cross-sectional area.
